(19) United States
(12) Patent Application Publication
(10) Pub. No.: US 2019/0098351 A1
(43) Pub. Date: Mar. 28, 2019

(54) METHOD FOR MANAGING THE ACCESS RIGHT TO AN ITEM OF DIGITAL CONTENT

(71) Applicant: ORANGE, Paris (FR)

(72) Inventors: Martin Conan, Chatillon Cedex (FR); Jean-Bernard Leduby, Chatillon Cedex (FR)

(21) Appl. No.: 16/139,693

(22) Filed: Sep. 24, 2018

(30) Foreign Application Priority Data
Sep. 22, 2017 (FR) 1758786

(51) Int. Cl. H04N 21/254; H04N 21/262; H04N 21/44

(52) U.S. Cl. CPC H04N 21/2541; H04N 21/44; H04N 21/2625

(57) ABSTRACT

A method for managing transfer of a rendering of an item of content onto a transfer device that is able to be controlled by several control devices. The method includes: rendering a first item of content controlled by a first control device; receiving, during the rendering, a request, originating from a second control device, to transfer a second item of content; and transmitting, to the second control device, an item of information representative of a waiting time for the transfer of the second item of content.

### TECHNICAL FIELD

The invention relates to a method for managing the use of a transfer device by several control devices. The targeted transfer device is inserted between a control device, at the origin of a request to access an item of content, and a rendering device; the role of the transfer device is to transfer the rendering of an item of content onto a device other than that at the origin of the access request. The role of this transfer device is, inter alia, to access the item of content and provide the item of content to the rendering device.

The transfer device may take the form of an electronic key (dongle in English) that is connected to the rendering device and equipped with a communication function, for example a wireless one of Wi-Fi type, so as to be able to connect to a network, for example a local area network.

The transfer and rendering device may form a single device.

The control device targeted above will be, in the examples described below, a mobile device such as a smartphone or a digital tablet.

### PRIOR ART

With the development of mobile networks and devices, it is nowadays possible to render digital multimedia content (video, audio, etc.) on a user's mobile device, for example a smartphone or a digital tablet.

However, in a certain number of situations, and in particular when the user of the mobile device is in a local area network, it is more agreeable for him to render the item of multimedia content, for example a film, on a television set or on another terminal of the local area network, for example a computer, having a larger screen than the mobile device. ‘Render’ is understood here to mean making the item of content available for the user: viewing, displaying, audio rendering, etc.

It is recalled here that a local area network, also called home network, is an IT network that links together, in a wired or wireless manner, terminals (computers, peripheral printer, rendering, storage devices etc.). A home network generally includes a router apparatus, also commonly called home gateway, or service gateway, which is an intermediary element ensuring the redirection, or routing, of data packets between the various terminals and the networks that are connected thereto. Such a home network often connects the various terminals using Wi-Fi technology. It is recalled here that the designation Wi-Fi (for ‘Wireless Fidelity’) groups together wireless transmission technologies, making it possible to create wireless IT networks based on the standards of the IEEE 802.11 family.

As the screen of the mobile device is often of small size, and the speakers of poor quality, it is not agreeable to render an item of multimedia content thereon. Moreover, it is awkward to render such content on the screen of a mobile device while using it for other functions at the same time, such as for example managing telephone calls, text messages, etc.

It is therefore beneficial from several points of view to transfer the rendering of the item of multimedia content to another device, termed transfer device.

To this end, products that make it possible to render multimedia content on a PC (personal computer) or a TV (television), while at the same time relieving the mobile device of the tasks of decoding, displaying, audio rendering, etc., which are inherent to the rendering of an item of digital content, have recently emerged.

In this category there are devices that are able to render digital content offered in the form of streams in real time, these devices taking the form of an electronic key that connects to an HDMI (from the English high-definition multimedia interface, which is an electrical and logic interface that allows the transfer of high-definition uncompressed multimedia digital data) multimedia port of a television. The item of multimedia content originating from an application, such as for example a progressive download application on the wide area network (WAN), such as for example YouTube©, is selected by the user on a first terminal connected to the local area network (smartphone, tablet, computer, etc.) and rendered on the television via the transfer device.

In this configuration, the main steps in terms of the transfer device are as follows, assuming that pairing has been performed:
opening a point-to-point communication channel between the portable device and the transfer device;
reception, by the transfer device, of an identifier of an item of digital content to be rendered;
accessing, by the transfer device, of the identified item of content on the content server.

One problem is that several users may wish to use one and the same transfer device simultaneously. A transfer of the rendering may therefore receive several transfer requests; in particular, the transfer device may receive a transfer request from a first control device while rendering on the rendering device is already taking place in connection with a second control device.

One solution for the transfer device consists in not taking into account the transfer request from the second control device. This request may be ignored or receive a message notifying that it is not possible to perform a transfer. This solution does not offer optimum quality of service as the user of the second control device receives a transfer denial; this denial without further action does not encourage use of the transfer function.

The invention aims to improve the situation.

The Invention

According to a first functional aspect, the invention relates to a method for managing the transfer of the rendering of an item of content, onto a transfer device that is able to be controlled by several control devices, characterized in that it comprises

a. a step of transferring the rendering of a first item of content controlled by a first control device;

b. a step of receiving, during the rendering, a request, originating from a second control device, to transfer a second item of content;

c. a step of transmitting an item of information to the second control device, the item of information being representative of a waiting time for the transfer of the second item of content.

The invention therefore proposes, when the transfer device is already currently transferring an item of content, to inform the requesting party of a possible transfer by providing a waiting time for performing the transfer. The user of the control device is therefore informed that the transfer is possible after a certain time.

According to a first particular mode of implementation of the invention, interruption, by the first control device, of the transfer of the rendering of the first item of content during rendering thereof triggers the transfer of the rendering of the second item of content. In this way, the second item of content is rendered automatically without the control device requesting the rendering of the item of content again.

An interruption may have several causes; it may be requested by a user wishing to stop the rendering; it may follow the rendering of the whole item of content, etc.

According to one variant of this first mode, the triggering of the transfer of the rendering of the second item of content is delayed. In other words, the rendering of the second item of content is preceded by a delay time. Ideally, this delay is calculated so as to take into account the time necessary for a user to move to the transfer device, implicitly the rendering device. The distance from the control device, or any other device that possibly serves to locate the user, may be calculated in such a way as to evaluate the movement time necessary to move to the transfer device.

According to a second particular mode of implementation of the invention, which may be implemented as an alternative or in addition to the preceding one, when the first item of content and the second item of content are the same, the item of information furthermore indicates that the requested item of content is already currently being rendered. In this way, the user that requested the transfer may either wait for the waiting time to expire or go to the rendering device without waiting as he knows that the item of content being rendered is the requested item of content; the latter case may be beneficial when the requested item of content is a programme able to be watched live, for example a televised sports programme, for example a football match or something else.

According to another, third particular mode of implementation of the invention, which may be implemented as an alternative or in addition, when several transfer requests are received, a waiting list of control device identifiers is created. Specifically, several control devices may request access during the rendering of the second item of content; this variant makes it possible to queue the various control devices in question; the queue preferably complies with the order in which the access requests are received.

According to a variant of this third mode, waiting times correspond to the control device identifiers. In this way, a user of a control device, in the established list, knows the control devices in the list and the respective waiting times.

According to another, fourth particular mode of implementation of the invention, which may be implemented as an alternative or in addition, the item of information is supplemented by a confirmation request; the control device being added to the waiting list only after confirmation. In other words, when the request is confirmed, a transfer reservation is made for the control device that requested the rendering of the second item of content. This mode makes it possible to include only the control devices that have confirmed the wish to transfer in the waiting list. If a confirmation is not made for a control device, the latter is not added to the waiting list.

According to one variant of this fourth mode, the reservation that is made is communicated, for example on demand, to the other control devices and/or to the transfer device. In this way, the user viewing the first item of content is informed that, following the rendering of the first item of content, and possibly for a given time, the first control device will not be able to use the transfer device and that only the second control device will be able to control the transfer device during the given period.

According to a first hardware aspect, the invention relates to a transfer device able to access an item of content stored on a content server, the transfer of the rendering of an item of content onto a transfer device being able to be controlled by several control devices, characterized in that it comprises a. a module for transferring the rendering of a first item of content controlled by a first control device;

b. a module for receiving, during the rendering, a request, originating from a second control device, to transfer a second item of content;

c. a transmission module able to transmit, to the second control device, an item of information representative of a waiting time for the transfer of the second item of content.

According to a second hardware aspect, the invention relates to a computer program able to be implemented on a device, such as defined above, the program comprising code instructions that, when it is executed by a processor, performs the steps of the method that are defined above.

The nature of the programs targeted above is arbitrary. They may be downloaded from a communication network and/or recorded on a computer-readable medium.

The invention will be better understood on reading the following description, given by way of example and with reference to the appended drawings, in which:

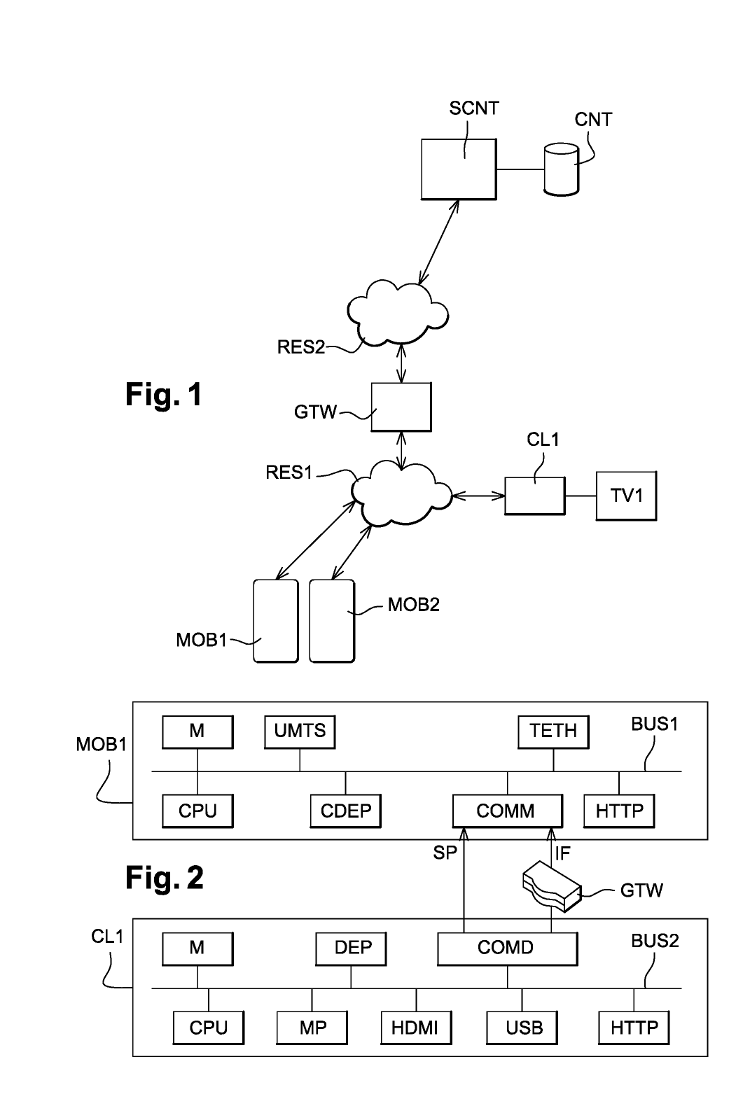

FIG. 1 shows an IT system on which an exemplary embodiment of the invention is illustrated.

FIG. 2 shows the circuits of a mobile device and of a transfer device.

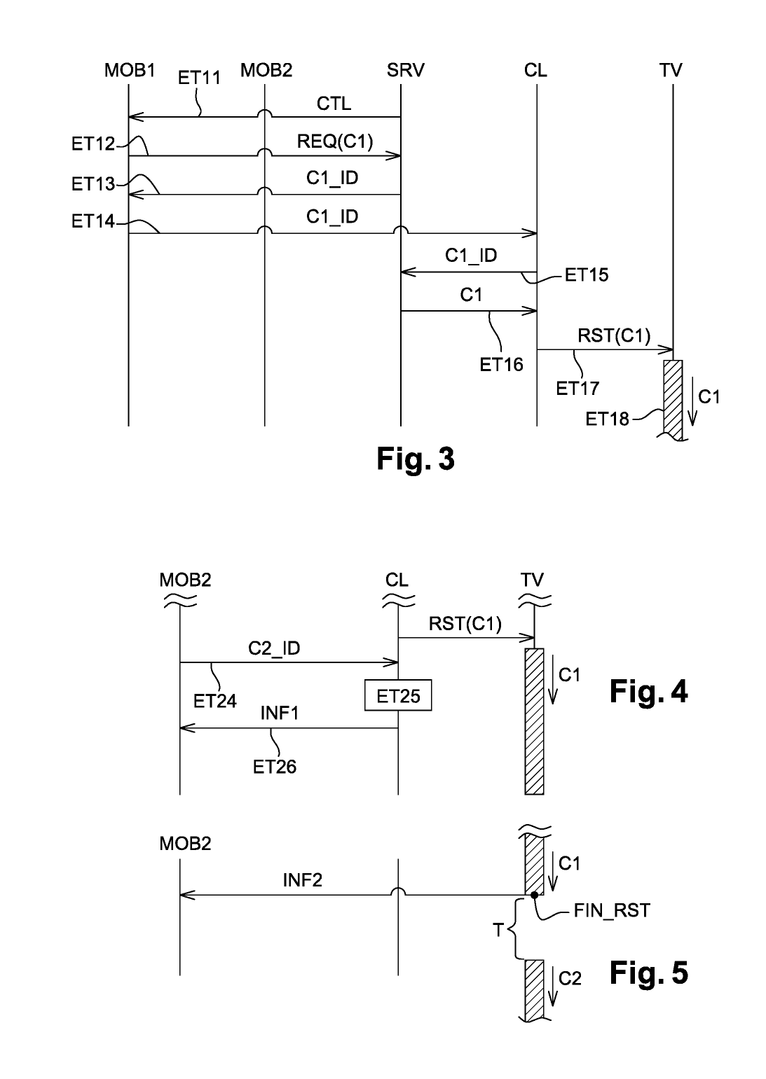

FIG. 3 is a timing diagram illustrating an embodiment of the method of the invention.

FIGS. 4 and 5 are timing diagrams illustrating a variant of the embodiment described with reference to FIG. 3, respectively.

### DETAILED DESCRIPTION OF AN EXEMPLARY EMBODIMENT ILLUSTRATING THE INVENTION

FIG. 1 shows a system SYS comprising control devices MOB1 and MOB2, which are illustrated by way of two mobile devices, namely smartphones; the number of control devices is irrelevant, and a single control device could be enough to implement the invention.

The system comprises a transfer device CL that in particular allows access to content in such a way as to be rendered on a rendering device TV.

The system also comprises a content server SRV able to deliver content on demand.

As explained in the preamble of the application, in our example, a transfer device takes the form of an electronic key (dongle in English) that is connected to the rendering device TV and equipped with a communication function, for example a wireless one of Wi-Fi type, so as to be able to connect to a communication network, for example a local area network RES1 managed by a home gateway GTW. The transfer device may also be a digital television decoder.

The server SRV may communicate with the gateway GTW via a second network RES2. In our example, this second network is a wide area network (WAN, as opposed to a local area network LAN).

The server SRV may communicate with the gateway GTW via this second network RES2.

Of course, the invention is not limited to this configuration. For example, the mobile devices and the key CL could very well access the content server without the aid of a gateway; for example, the mobile devices and the transfer device could communicate via a mobile network.

In our example, the mobile devices and the transfer device are able to establish connections with the service gateway GTW that is linked to the second network RES2.

The first network RES1 is for example a local IP network (IP for Internet Protocol, the name of the basic protocol for Internet networks and, by extension, the name of the network itself) and the second network is for example of ADSL type (from the English asymmetric digital subscriber line).

The content server SRV hosts in particular content to be made available to devices, in particular to those of the local area network RES1. The chosen example relates to a content server; however, this server may be broken up into several apparatuses, for example, the content may be stored in a database separate from the server.

The service gateway GTW includes a Wi-Fi communication function or access point (in English: AP), allowing it to communicate wirelessly with the devices of the local area network. This access point includes a bidirectional radio module for sending or receiving signals in the local area network.

A mobile device MOB1/MOB2 is for example a personal computer (PC), a smartphone, a PDA (personal digital assistant), a digital tablet, or else a portable computer, which may or may not be connected to a mobile network (not shown).

A rendering device is for example a television TV.

In our example, a rendering device corresponds to a transfer device. Of course, the invention could be implemented with a transfer device associated with several rendering devices. Thus, a transfer device and a rendering device could constitute one and the same apparatus, for example a connected television including a transfer device.

An application running on the mobile device MOB1/MOB2, in our example a ‘live’ content TV application, that is to say of ‘television channel’ type, or on demand TV application, allows the user to select an item of multimedia content intended to be rendered on a television.

The television TV is associated with the transfer device, connected in our example to an HDMI video port of the television and taking the form of an electronic key (dongle in English).

Following selection of a specific function on a mobile device (for example a button able to be selected by pressing in the case of a touchscreen), the item of multimedia content is directed to the key and is able to be played on the television TV; in other words the rendering of the item of content is transferred to the television TV. The electronic key CL may then itself connect to the content server SCN of the WAN network RES on which it directly recovers the content, possibly with a quality or a resolution higher than the initial one of the mobile, in our example without passing via the mobile device.

It will be seen in our example that an item of content is downloaded from the content server SRV to the transfer device passing via the service gateway GTW.

It will be noted here that the transfer of the item of content has several advantages:
The mobile device may be relieved from a task that consumes a great deal of resources (decoding, displaying the video, etc.), thereby enabling it to provide other functions for the user at the same time (e.g. view a message, process a text message, etc.);
the quality and/or the resolution of the item of multimedia content may be higher on the TV than on the mobile device, thus improving comfort for the user;
The mobile may serve as a remote controller for basic functions relating to the item of content, such as for example stopping rendering (‘pause’), restarting (‘play’), controlling the volume (silence or ‘mute’, increasing the volume ‘vol+’, lowering the volume ‘vol-’), etc.

It is assumed that, in a preliminary step (not shown), the two devices, mobile device and transfer device, have both connected to the local area network, that is to say to the service gateway GTW of the local area network. In our example, once the two apparatuses are connected to the network via the service gateway, they establish communication. To this end, the mobile device in question first of all discovers (D) the presence of one or more peripheral devices of this type on the network. This discovery step corresponds to an operation that is well known to those skilled in the art and that may be implemented in the form of a request in accordance with a local area network protocol, for example the UPnP standard. It is recalled that the aim of the UPnP standard is to allow terminals to connect easily and communicate simply within a local area network. It constitutes a set of communication protocols based on the IP protocol and enacted by the UPnP standardization forum (‘UPnP Forum’). To control the terminals of the network, UPnP uses control points (CP for short). A control point conventionally sends what are called discovery messages (MSEARCM to the various terminals of the network so as to recover in return a description of the terminals corresponding to the request. These discovery messages are usually sent in point-to-multipoint communication mode, also called multicast mode, from the control point to the terminals. In our example, a terminal apparatus compatible with the UPnP standard responds to these request messages, and additionally sends, with regular frequency, presence messages (ALIVE) to signify that it is active and connected to the network. The control point of the local area network, which is situated in this case on the mobile device, sends search messages (SEARCH) for devices of a given type, in this case electronic transfer keys, in multicast mode.

The key in question responds to the discovery request. The mobile device in question possibly selects a key (and therefore an associated television or PC) from among those that are discovered.

A communication channel (‘WebSocket’—WS) is established between the mobile device and the electronic key in order to exchange commands and/or data. In our example, the WebSocket protocol makes it possible to provide bidirectional communications between a client and a server on a network using the HTTP (from the English Hypertext Transport Protocol) protocol, a client-server communication protocol developed for Internet networks, and in particular the web. By extension, WebSocket is a standard that designates both a network protocol and a programming interface that is able to be used by an application on any client and web server. The protocol has been standardized by the body IETF (Internet Engineering Task Force) in its specification RFC 6455 (referenced ‘IETF Request For Comments: 6455’) and the corresponding programming interface by the body W3C (referenced: The Web Sockets API; W3C Candidate Recommendation 20 Sep. 2012).

Thereafter, when the user selects an item of content (C) and presses the redirection button, for example on a touchscreen of the mobile device, the application of the mobile device asks the electronic key to launch the application to transfer the rendering of the item of content C referenced by its identifier (C_ID); the identifier is then transformed into a URL, for example,
http://www.monserveurcom/C_ID

The electronic key then accesses a content server SRV in order to recover the item of digital content C_ID for example in streaming mode by virtue of this URL. By definition, the streaming mode corresponds to a continuous download of multimedia content. The client terminal (in this case the electronic key) performs a request by downloading, in a first step, a document describing the parameters for accessing the service via the HTTP protocol, and then accesses the item of content on the content server SRV, transmits it to the rendering device TV, and the service effectively starts, that is to say that the display device TV is able to receive and display the item of content C.

During the downloading of the item of content, commands (CM) may be transmitted to the electronic key (pause, play, fast forward, etc.) and status messages may be received coming from the electronic key (metadata, state of the transfer device, etc.) to the mobile device at the origin of the commands.

FIG. 2 shows a hardware architecture of a transfer device connected to a mobile device of the local area network.

The mobile device MOB1 or MOB2 comprises, as is conventional, memories M articulated around a processor CPU. The memories may be of ROM (from the English read-only memory) or RAM (from the English random access memory) type, removable or fixed, etc. It communicates with the local area network RES1 via the communication module (COMM), which enables it to connect with wires (via an Ethernet cable) or wirelessly (via a radio channel of Wi-Fi, Bluetooth, ZigBee, etc. type) to the gateway GTW or to another device of the local area network. As described previously, in our example, an ‘ad-hoc’ point-to-point communication channel is used for an initial phase of establishing the session between a mobile device and a transfer device. This channel may be of Wi-Fi Direct, Bluetooth, etc. type. Then, according to one embodiment of the invention, the two devices dialogue in infrastructure mode via the gateway GTW.

According to another embodiment of the invention, the mobile device may serve as a gateway in ‘tethering’ mode, and the two devices dialogue in infrastructure mode IF without the service gateway. A mobile device (MOB1 or MOB2) to this end comprises an access point or tethering mode (TETH), which enables it to transform into a gateway, so as to communicate with the second network RES2, which may in this case be combined with the mobile IP network.

In our example, the mobile device also comprises a mobile radio module (for example, UMTS) that enables it to dialogue with a third network, called mobile network of UMTS network type. Lastly, it includes an application (CDEP) responsible for controlling the transfer, in particular the communication with the transfer device. The module CDEP, which may be software and/or hardware, is capable in particular of performing the following actions: selecting a transfer device (from among several), requesting establishment of a point-to-point communication channel with this device in order to transmit identifiers of the local area network, recover and store the identity of the transfer device, select an item of content and transmit an identifier of this item of content to the transfer device, control the rendering of the item of content, etc.

Part of the memory MEM is linked to the Wi-Fi access point and stores, inter alia, the parameters for identifying the home gateways that the mobile device is able to access, the parameters for identifying and associating the home apparatuses with the access point when the mobile device is in ‘router’ mode (tethering) (table of identifiers comprising the unique identifiers of the home terminals that have already been authorized to access the home network via the access point, routing elements, etc.), the parameters for identifying the transfer devices of the local area network (names, features, etc.).

The transfer device also includes a communication module of HTTP type for providing communications of HTTP type, for example of WebSocket (WS) type; it will be noted that communication of WS type is possible on a Bluetooth link.

All of the modules communicate with one another, as is conventional, via a data bus BUS1.

In our example, the transfer device also comprises memories M articulated around a processor CPU. The memories may be of ROM, RAM or other type. Part of the memory M stores, inter alia, the parameters for identifying the home gateways that the transfer device is able to access and the identity of the transfer device (for example, ‘dongle_number_36’ or ‘key#2’). It communicates with the local area network RES1 and the mobile device via the communication module (COMD), which enables it in particular to connect wirelessly (Wi-Fi) to the service gateway GTW in infrastructure mode (via the link IF) or directly to the mobile device (link SP) in ‘Wi-Fi Direct’ or Bluetooth mode. In our example, it is supplied with power via a USB serial interface. It also includes:
an application (DEP) responsible for communication with a mobile device and for transferring the item of content. This module is capable in particular of establishing communication, preferably private communication, with the mobile device via the communication module COMD, of accepting a request to search for streaming of an item of content referenced by its identifier C_ID on the network instead of the mobile device, of receiving commands to control the rendering on the part of the mobile device acting as a remote controller, of transmitting identity information, state information, to it, etc.
a media player (MP) capable of rendering (receiving, decoding, preparing) the streams in streaming mode and of delivering them to the rendering device (TV); the media player includes, inter alia, a set of transfer devices (audio, video, etc.) able to decode the multimedia content, and an interface for communicating with the mobile device that is able to interpret orders coming therefrom (pause, rewind, control the volume, etc.)
a module for interfacing with the rendering device (HDMI) that is capable of interfacing physically and logically with the television in order to transmit the decoded item of multimedia content (audio and video) to it.
an HTTP communication module.

All of the modules communicate with one another, as is conventional, via a data bus BUS2.

Several devices may make a request to transfer an item of content to the same transfer device. This configuration poses a problem because the transfer device may be busy when it receives a transfer request; specifically, the transfer device may currently be rendering a first item of content on behalf of a first control device MOB1; in this case, a management module manages the requests to access the transfer device in the manner described below.

According to the invention, the method comprises the steps:
a step of rendering the first item of content CNT1 via the transfer device; this first item of content being rendered on behalf of the first mobile device MOB1;
during the rendering of the first item of content CNT1, the transfer device receives a request, from the second mobile device MOB2, to transfer a second item of content;
a step of transmitting an item of information to the control device, the item of information being representative of a waiting time for the transfer of the second item of content.

In order to illustrate the principle of the invention, an exemplary embodiment will now be described with reference to FIGS. 3 and 4.

In this example, it is assumed that the home network comprises two mobile devices MOB1 and MOB2, the first being at the origin of the request to render the first item of content CNT1 and the second mobile device MOB2 that will request rendering of a second item of content CNT2 during the rendering of the first item of content CNT1 on the television TV.

Two phases will be described with reference to the two FIGS. 3 and 4, respectively.

The first phase PH1 is dedicated to a rendering request originating from the first mobile device MOB1. In this first phase, it is assumed that the transfer device is available to perform a transfer and therefore receive a request to access an item of content.

The second phase PH2 is dedicated to reception of a transfer request by the transfer device, originating from the second mobile device MOB2, at the same time as the rendering of the first item of content.

The first phase PH1 comprises several steps referenced ET1n.

In a first step ET11, a user accesses a catalogue CTL of audiovisual content on the server SRV. In this catalogue, the user selects, by way of the first mobile device MOB1, an item of content C1_ID, for example a video.

In a second step ET12, a request to access the item of content C1 REQ(C1) is transmitted from the first mobile device MOB1 to the content server SRV.

In a third step ET13, the server responds by providing the identifier of the requested item of content CLID to the mobile device MOB1.

In a fourth step ET14, the first mobile device MOB1 receives and transmits this identifier to the transfer device CL.

In a fifth step ET15, the transfer device CL connects to the content server SRV and requests reception of the item of content having the identifier CLID.

In a sixth step ET16, the item of content is received by the transfer device so as to be rendered on the television TV.

In a seventh step ET17 RST(C1_ID), the key decodes the item of content and requests rendering of the item of content C1 on the TV.

The second phase PH2 comprises several steps referenced ET2n-Ck (k=1, 2). In this second phase, the second mobile device will request rendering of a second item of content C2 while the transfer device is currently rendering the first item of content C1.

Steps ET21 to ET23 are the same as steps ET11 to ET13, with the exception that the item of content selected in the second step ET22 is a second item of content C2 instead of the first item of content C1. It will nevertheless be seen hereinafter that the items of content C1 and C2 may be the same; one and the same film for example.

In a fifth step ET24, the second mobile device MOB2 receives and transmits the identifier C2-ID of the second item of content to the transfer device CL.

In a fifth step ET25 of this second phase PH2, the transfer device CL receives the identifier C2_ID.

As the transfer device is busy rendering the first item of content C1, the management module, present on the transfer device CL, transmits an item of information INF1, called first item of information, to the second mobile device MOB2 in a sixth step ET26. This item of information gives an indication of a waiting time before the requested transfer is performed.

The item of information may of course include information other than the time, such as for example data relating to the transferred item of content currently being rendered.

The waiting time may correspond to the remaining rendering time of the item of content currently being rendered. If the first item of content C1 is a film, the remaining time may be displayed. The remaining time may also be provided by a user viewing the first item of content; specifically, this user might not intend to view the whole of the first item of content; he may then indicate a likely time of use of the transfer device CL.

Thus, the rendering of the first item of content may be interrupted during rendering thereof. In this configuration, the interruption of the rendering of the first item of content triggers transmission of a second item of information representative of the interruption to the control device, signifying that the transfer device is available. The interruption may also trigger automatic rendering of the second item of content.

According to one variant, the end of the rendering of the first item of content C1 automatically triggers the rendering of the second item of content C2.

Preferably, the start of the rendering of the second item of content is delayed until confirmation by the user. With reference to FIG. 5, the end of the rendering of the first item of content is notified to the second control device; to this end, the transfer device transmits a new item of information INF2, called second item of information, indicating the end of the rendering of the first item of content C1; the transfer device CL therefore becomes available for performing a new transfer. Thus, the rendering of the second item of content C2 may also be delayed by a time T sufficient to move in front of the screen of the television TV, the rendering taking place automatically upon expiry of this delay time T.

This delay time may be calculated taking into account the location of the second mobile device MOB2, or any other device able to locate the user wishing to access the second item of content; this other device may be for example a connected watch.

It may be the case that the second item of content corresponds to the first item of content; this may be the same film for example. In this configuration, the first item of information informs that the requested item of content is currently being rendered on the transfer device.

According to another variant, the transmission step is followed by queueing of the identifier of the device at the origin of the transfer request. If several other mobile devices request access, a waiting list is therefore created.

According to another embodiment, when several transfer requests are received by the transfer device, a waiting list of control device identifiers is created.

According to one variant of this embodiment, a remaining time corresponds to each control device identifier.

According to another variant of this embodiment, the item of information is supplemented by a confirmation request; when the request is confirmed, the identifier of the mobile device in question is added to the waiting list and a transfer reservation is made for this control device. The reservation thus made is communicated to the control device and/or to the transfer device. If the confirmation is not made, the identifier of the device in question is not included in the waiting list.

It should lastly be noted that, to perform the method of the invention, a transfer device comprises the following modules:
a module for rendering a first item of content controlled by a first control device;
a module for receiving, during the rendering, a request, from a second control device, to transfer a second item of content,
a transmission module able to transmit, to the second control device, an item of information representative of a waiting time for the transfer of the second item of content.

It should be clarified here that the term module may correspond equally to a software component or to a hardware component or to a set of software and hardware components, a software component itself corresponding to one or more computer programs or subroutines or, more generally, to any element of a program able to implement a function or a set of functions such as described for the modules in question. In the same manner, a hardware component corresponds to any element of a hardware assembly able to implement a function or a set of functions for the module in question (integrated circuit, chip card, memory card, etc.).
6. Method according to claim 1 or 5, characterized in that the item of information (INF1) is supplemented by a confirmation request, and in that the control device is added to the waiting list only after confirmation.
7. Transfer device (CL1-CL3) able to access an item of content stored on a content server (SRV), the transfer of the rendering of an item of content onto a transfer device being able to be controlled by several control devices, characterized in that it comprises
   a. a module for transferring the rendering of a first item of content controlled by a first control device;
   b. a module for receiving, during the rendering, a request, originating from a second control device, to transfer a second item of content;
   c. a transmission module able to transmit, to the second control device, an item of information representative of a waiting time for the transfer of the second item of content.
8. Computer program able to be implemented on a device, such as defined in claim 7, the program comprising code instructions that, when it is executed by a processor, performs the steps of the method that are defined in claim 1.

1. A method comprising:
managing a transfer of a rendering of an item of content onto a transfer device that is able to be controlled by several control devices, wherein the managing comprises the following acts performed by a transfer device:
transferring the rendering of a first item of content onto the transfer device, controlled by a first control device;
receiving, during the rendering, a request, originating from a second control device, to transfer a second item of content; and
transmitting, to the second control device, an item of information representative of a waiting time for the transfer of the second item of content.

2. The method according to claim 1, wherein interruption, by the first device, of the transfer of the rendering of the first item of content during rendering thereof triggers the transfer of the rendering of the second item of content.

3. The method according to claim 2, wherein the triggering of the transfer of the rendering of the second item of content is delayed.

4. The method according to claim 1, wherein, when the first item of content and the second item of content are the same, the item of information furthermore indicates that the requested item of content is already currently being rendered.

5. The method according to claim 1, wherein, when several transfer requests are received, a waiting list of control device identifiers is created.

6. The according to claim 1, wherein the item of information is supplemented by a confirmation request, and wherein the second control device is added to the waiting list only after confirmation.

7. A transfer device able to access an item of content stored on a content server, the transfer device comprising:
a processor; and
a non-transitory computer-readable medium comprising instructions stored thereon, which when executed by the processor configure the transfer device to perform acts comprising:
enabling control of a transfer of a rendering of an item of content onto the transfer device by several control devices;
transferring the rendering of a first item of content controlled by a first control device;
receiving, during the rendering of the first item of content, a request, originating from a second control device, to transfer a second item of content; and
transmitting, to the second control device, an item of information representative of a waiting time for the transfer of the second item of content.

8. A non-transitory computer-readable medium comprising a computer program stored thereon comprising code instructions that, when executed by a processor of a transfer device, configure the transfer device to perform a method comprising:
managing a transfer of a rendering of an item of content onto a transfer device that is able to be controlled by several control devices, wherein the managing comprises the following acts performed by a transfer device:
transferring the rendering of a first item of content onto the transfer device, controlled by a first control device;
receiving, during the rendering, a request, originating from a second control device, to transfer a second item of content; and
transmitting, to the second control device, an item of information representative of a waiting time for the transfer of the second item of content.
